(19) United States
(12) Patent Application Publication
(10) Pub. No.: US 2003/0076952 A1
(43) Pub. Date: Apr. 24, 2003

(54) Earphone capable of automatically receiving telephone calls

(76) Inventor: Hsi Kuang Ma, Taipei (TW)

Correspondence Address: JOHNSON & ASSOCIATES, P.C., 14625 Baltimore Avenue #282, Laurel, MD, 20707, US

(21) Appl. No.: 10/025,450

(22) Filed: Dec. 26, 2001

(30) Foreign Application Priority Data
Oct. 24, 2001 (TW) 090218184

(51) Int. Cl. H04M 1/00; H04M 9/00

(52) U.S. Cl. 379/430

(57) ABSTRACT

An earphone capable of automatically receiving telephone calls includes an earphone having an earphone stereo plug and at least one speaker for outputting audio signals, a microphone for inputting voice signals, and a control device having an earphone stereo socket, a radio stereo plug and a hand-held mobile phone stereo plug. The earphone stereo socket is coupled to the earphone stereo plug. The radio stereo plug is coupled to a portable CD player or a radio stereo socket of a radio for inputting stereo audio signals. The hand-held type mobile phone plug is coupled to the hand-held type mobile phone socket of a hand-held type mobile phone for inputting voice signals. In a state of listening to the CD player or radio, the control device controls the speaker to output stereo audio signals. When the mobile phone receives an incoming call, the control device will output a control signal to cause the speaker to output the voice signals of the mobile phone.

### BACKGROUND OF THE INVENTION

1. Field of The Invention

The invention relates to an earphone capable of automatically receiving telephone calls, more particularly to an earphone which outputs audio signals from a portable CD player or a radio in a normal state and which, when a hand-held type mobile phone connected thereto receives an incoming call, automatically switches to output voice signals of the hand-held type mobile phone.

2. Description of Related Art

With the advance of technology, hand-held type mobile phones are very popular. It is not uncommon to see people having a hand-held type mobile phone fastened to a belt while listening to music from a portable CD player or radio via an earphone. When the mobile phone receives an incoming call, the user must remove the earphone in order to take the call. There is available in the marketplace a kind of hand-free earphone for hand-held mobile phones, which allows the user to converse with the caller via the earphone without holding the mobile phone. However, such an earphone is not equipped with functions that enable the user to listen to music from the portable CD player or radio.

### SUMMARY OF THE INVENTION

The primary object of the present invention is to provide an earphone capable of automatically receiving telephone calls to enable the user to listen to music from a portable CD player or radio in a normal state and to automatically switch to output voice signals of a hand-held type mobile phone.

Accordingly, the earphone capable of automatically receiving telephone calls of the invention includes an earphone having an earphone stereo plug and at least one speaker for outputting audio signals, a microphone for inputting voice signals, and a control device having an earphone stereo socket, a radio stereo plug and a hand-held mobile phone stereo plug. The earphone stereo socket is coupled to the earphone stereo plug. The radio stereo plug is coupled to a portable CD player or a radio stereo socket of a radio for inputting stereo audio signals. The hand-held type mobile phone plug is coupled to the hand-held type mobile phone socket of a hand-held type mobile phone for inputting voice signals. In a state of listening to the CD player or radio, the control device controls the speaker to output stereo audio signals. When the mobile phone receives an incoming call, the control device will output a control signal to cause the speaker to output the voice signals of the mobile phone.

### BRIEF DESCRIPTION OF THE DRAWINGS

The foregoing and other features and advantages of the present invention will be more clearly understood from the following detailed description and the accompanying drawings, in which,

FIG. 1 is a schematic view of the preferred embodiment of an earphone capable of automatically receiving telephone calls according to the present invention; and

FIG. 2 is a circuit diagram of a control device of the preferred embodiment.

### DETAILED DESCRIPTION OF THE PREFERRED EMBODIMENTS

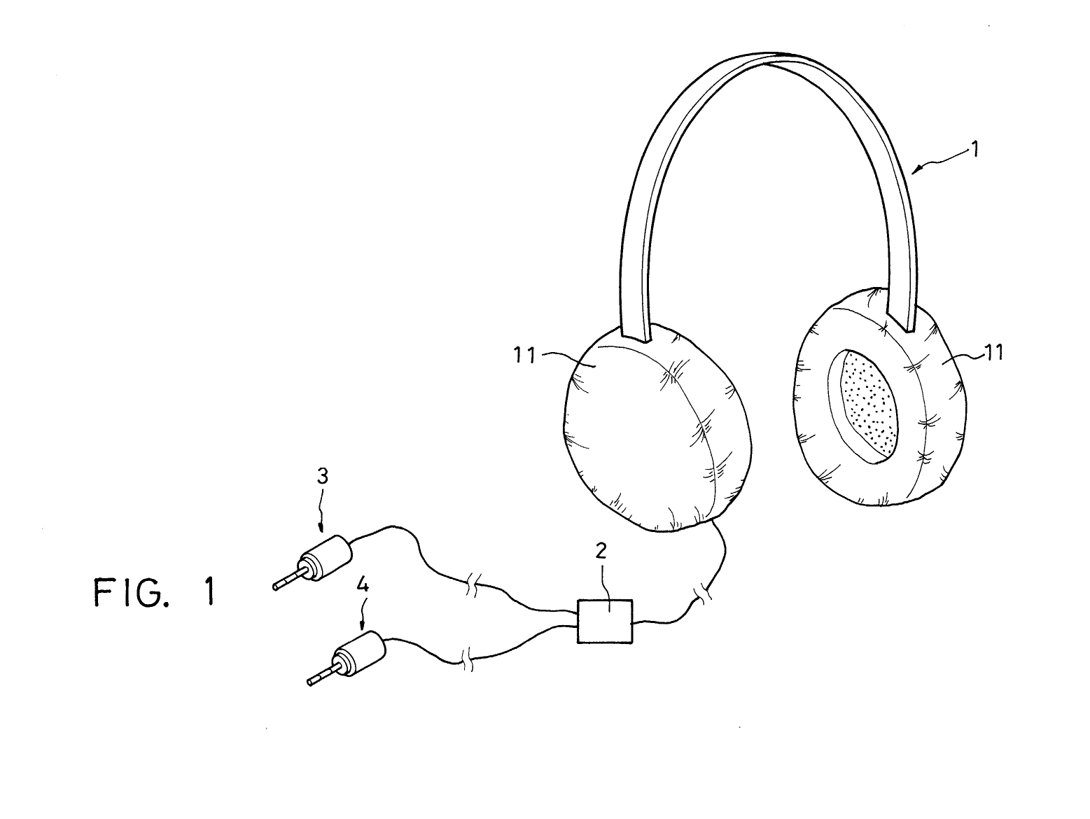

Referring to FIG. 1, the preferred embodiment of an earphone capable of automatically receiving telephone calls according to the present invention is shown to include an earphone 1 which has an earphone stereo socket (not shown) and at least one speaker 11 for outputting audio signals, a microphone 12 for inputting voice signals, and a control device 2 having a stereo socket (not shown), a radio stereo plug 3 and a hand-held type mobile phone stereo plug 4. The stereo socket is disposed to couple with the earphone stereos socket (not shown) of the earphone 1, which is exemplified as an independent earphone 1 in this embodiment. By virtue of the coupling between the earphone stereo plug and the stereo socket, the earphone 1 can be connected to the control device 2. However, the earphone 1 and the control device 2 can be formed integrally without the need for the coupling between the earphone stereo plug and the stereo socket. At this time, there is no need for the earphone stereo plug and the stereo socket. The radio stereo plug 3 is provided to couple to a portable CD player or a radio stereo socket (i.e., earphone socket, not shown) of a radio. The hand-held type mobile phone stereo plug 4 is provided to couple to a hand-held type mobile phone stereo socket (i.e., earphone socket, not shown) of a hand-held mobile phone.

In a normal state, the user can listen to audio recordings using the portable CD player or listen to the radio by using the control device 2 to control the speaker 11 of the earphone 1 to output audio signals of the portable CD player or the radio. When the hand-held type mobile phone (not shown) receives an incoming call, it will output a ringing control signal to the control device 2. The control device 2 then controls the speaker 11 of the earphone 1 to output a voice signal of the hand-held type mobile phone. As such, with the user of the earphone of the invention that is capable of receiving telephone calls, the user can listen to music using the portable CD player or the radio at normal times. When a call is coming in, the earphone will automatically switch and receive voice signals of the hand-held type mobile phone. Hence, by having only one earphone 11, the user can use the radio or the hand-held type mobile phone at the same time.

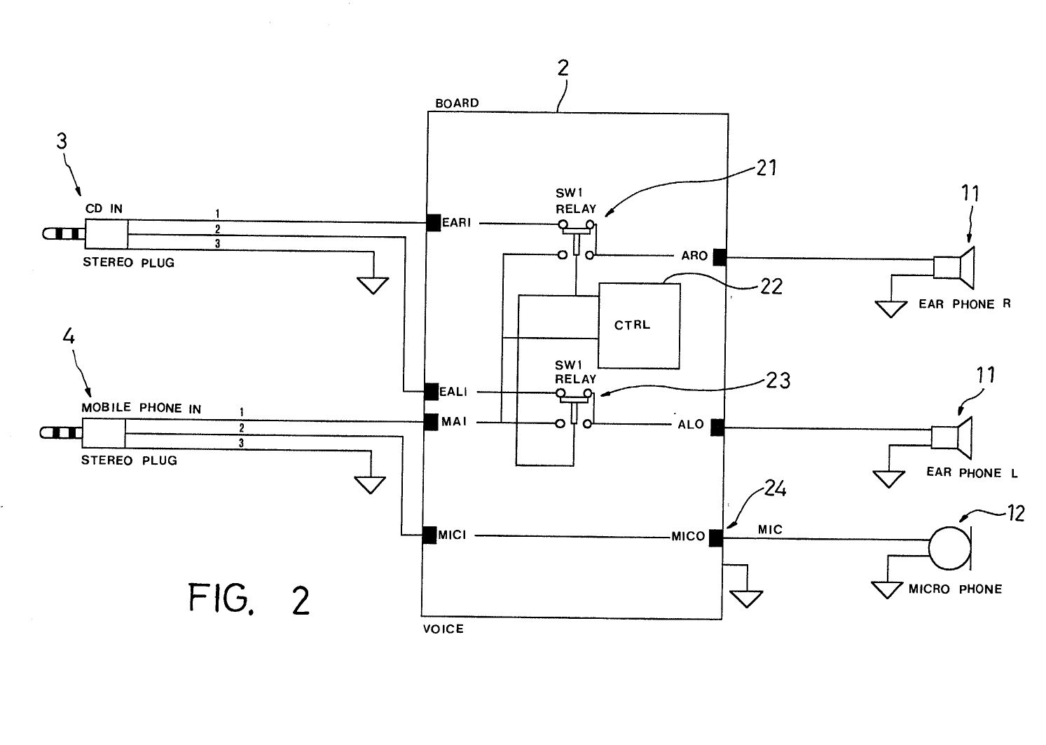

Referring to FIG. 2, the control device 2 of the present invention is shown to include: a first switch loop 21 which has a first contact unit and a second contact unit, the first contact unit being coupled to the radio stereo plug 3 for inputting a right-channel audio signal to the earphone 1, the second contact unit being coupled to the hand-held type mobile phone stereo plug 4 for inputting a voice signal to the earphone 1; a second switch loop 23 which has a first contact unit and a second contact unit, in which the first contact unit is coupled to the radio stereo plug 3 for inputting a left-channel audio signal to the earphone, the second contact unit being coupled to the hand-held type mobile phone stereo plug 4 for inputting a voice signal to the earphone 1; a microphone input socket 24 coupled to the hand-held type stereo plug and the microphone 12 for outputting the voice signal received by the microphone 12 to the hand-held type mobile phone; and a control circuit 22 coupled to the first switch loop 21 ad the second switch loop 23 for controlling “on” and “off” operations of the first and second switch loops 21, 23, the control circuit 22 having a battery unit to maintain normal operations of the functions.

In the mode of listening to music using the portable CD player or the radio, the first contact units of the first switch loop 21 and the second switch loop 23 are connected electrically so that stereo sound of the right channel audio signal and the left channel audio signal are outputted to the speaker 11. When the hand-held mobile phone receives an incoming call, the audio frequency signals generated thereby is inputted into the control circuit 22 via the hand-held mobile phone stereo plug 4. Via control of the control circuit 22, the second contact units of the first switch loop 21 and the second switch loop 23 are connected electrically so that the first contact units are disconnected. Hence, the stereo sound from the portable CD player or the radio can be interrupted to permit output of voice signals from the caller via the speaker 11. The voice signal from the recipient can also be transmitted to the hand-held type mobile phone via the microphone 12.

In view of the aforesaid, the earphone capable of automatically receiving telephone calls according to the present invention has the following advantages over the prior art: only one earphone is needed to permit simultaneous use of a portable CD player or radio and a hand-held type mobile phone, unlike the prior art which requires the removal of the earphone in order to receive a phone call using the hand-held type mobile phone.

Although the present invention has been illustrated and described with reference to the preferred embodiment thereof, it should be understood that it is in no way limited to the details of such embodiment but is capable of numerous modifications within the scope of the appended claims.

What is claimed is:

1. An earphone capable of automatically receiving telephone calls, comprising:
an earphone having an earphone stereo plug and at least one speaker for outputting an audio signal;
a microphone for inputting a voice signal; and
a control device having an earphone stereo socket, a radio stereo plug and a hand-held type mobile phone stereo plug, said earphone stereo socket being coupled to said earphone stereo plug, said radio stereo plug being coupled to a portable CD player or a radio stereo socket of a radio for inputting a stereo audio signal, said hand-held type mobile phone stereo plug being coupled to a hand-held type mobile phone stereo socket of a hand-held type mobile phone for inputting a voice signal;
wherein, in a normal mode of listening to the portable CD player or the radio, said control device controls said speaker to output said stereo audio signal; when said hand-held type mobile phone receives an incoming call, said control device will output a control signal to cause said speaker to output said voice signal of the hand-held type mobile phone.

2. The earphone capable of automatically receiving telephone calls as claimed in claim 1, wherein said control device further includes:
a first switch loop which has a first contact unit and a second contact unit, said first contact unit being coupled to said radio stereo plug for inputting a right-channel audio signal to said earphone, said second contact unit being coupled to said hand-held type mobile phone stereo plug for inputting said voice signal to said earphone;
a second switch loop which has a first contact unit and a second contact unit, in which said first contact unit is coupled to said radio stereo plug for inputting a left-channel audio signal to said earphone, said second contact unit being coupled to said hand-held type mobile phone stereo plug for inputting said voice signal to said earphone;
a microphone input socket coupled to said hand-held type stereo plug and said microphone for outputting said voice signal received by said microphone to the hand-held type mobile phone; and
a control circuit coupled to said first switch loop and said second switch loop for controlling “on” and “off” operations of said first and second switch loops such that when the hand-held type mobile phone receives an incoming call, said control signal generated thereby causes said second contact units of said first switch loop and said second switch loop to be on while said first contact units are disconnected so that said voice signal can be outputted via said earphone.

3. The earphone capable of automatically receiving telephone calls as claimed in claim 2, wherein said control circuit has a battery to maintain normal operations.

4. An earphone capable of automatically receiving telephone calls, comprising:
an earphone having at least one speaker for outputting an audio signal;
a microphone for inputting a voice signal; and
a control device having a radio stereo plug and a hand-held type mobile phone stereo plug, wherein said radio stereo plug being coupled to a portable CD player or a radio stereo socket of a radio for inputting a stereo audio signal, said hand-held type mobile phone stereo plug being coupled to a hand-held type mobile phone stereo socket of a hand-held type mobile phone for inputting a voice signal;
wherein, in a normal mode of listening to the portable CD player or the radio, said control device controls said speaker to output said stereo audio signal; when said hand-held type mobile phone receives an incoming call, said control device will output a control signal to cause said speaker to output said voice signal of the hand-held type mobile phone.

5. The earphone capable of automatically receiving telephone calls as claimed in claim 4, wherein said control device further includes:
a first switch loop which has a first contact unit and a second contact unit, said first contact unit being coupled to said radio stereo plug for inputting a right-channel audio signal to said earphone, said second contact unit being coupled to said hand-held type mobile phone stereo plug for inputting said voice signal to said earphone;
a second switch loop which as a first contact unit and a second contact unit, said first contact units being coupled to said radio stereo plug for inputting a left-channel audio signal to said earphone, said second contact units being coupled to said hand-held type mobile phone stereo plug for inputting said voice signal to said earphone;
a microphone input socket coupled to said hand-held type stereo plug and said microphone for outputting said voice signal received by said microphone to the hand-held type mobile phone; and
a control circuit coupled to said first switch loop and the second switch loop for controlling “on” and “off” operations of said first and second switch loops such that when the hand-held type mobile phone receives an incoming call, said control signal generated thereby causes said second contact units of said first switch loop and said second switch loop to be on while said first contact units are disconnected so that said voice signal can be outputted via said earphone.

6. The earphone capable of automatically receiving telephone calls as claimed in claim 4, wherein said control circuit has a battery unit for maintaining normal operations.
